(19) United States
(12) Patent Application Publication
(10) Pub. No.: US 2020/0126362 A1
(43) Pub. Date: Apr. 23, 2020

(54) GAMES OF CHANCE

(71) Applicant: Trepp Enterprises, Inc., Reno, NV (US)

(72) Inventors: Warren TREPP, Reno, NV (US); John M. HAMMOND, Livonia, NY (US)

(73) Assignee: Trepp Enterprises, Inc., Reno, NV (US)

(21) Appl. No.: 16/544,286

(22) Filed: Aug. 19, 2019

Related U.S. Application Data
(60) Provisional application No. 62/746,618, filed on Oct. 17, 2018.

(51) Int. Cl. G07F 17/32

(52) U.S. Cl. CPC G07F 17/3288; G07F 17/3258; G07F 17/3227

(57) ABSTRACT

Games of chance are disclosed. In one of the games of chance, a Player communicates to a computer a future indeterminate event and outcome upon which he wishes to wager. The computer accesses archival input data on past events relevant to possible outcomes of the future indeterminate event and accesses live input data from at least one of a sensor or an imaging device acquiring the live input data at the future indeterminate event, executes an algorithm to calculate odds for the specified possible outcome of the specified future indeterminate event, and offers the Player the opportunity to make a wager at the calculated odds. If the Player makes the wager, the computer compares in real time the actual outcome of the specified future indeterminate event with the specified possible outcome defined by the Player, and if the Player's wager is correct, a payout is made to the Player.

### CROSS-REFERENCE TO RELATED PATENT APPLICATIONS

This application claims the benefit of U.S. Provisional Patent Application No. 62/746,618 filed Oct. 17, 2018, the disclosure of which is/are incorporated herein by reference. The above benefit claim is being made in an Application Data Sheet submitted herewith in accordance with 37 C.F.R. 1.76 (b)(5) and 37 C.F.R. 1.78.

### BACKGROUND

### Technical Field

Games of chance, and in particular, wagering games that may be played in a physical setting such as a casino, or played virtually via execution using a computer.

### Description of Related Art

Games of chance have been played for thousands of years, both as a recreational pursuit, and with the intention of winning money, or some other form of consideration. Additionally, commercial enterprises (often referred to as casinos) that offer games of chance have also existed throughout civilization. These enterprises seek to earn money by enticing people to play the games, these players themselves hoping to win money from the casino. On the average, the casinos make money because the odds that they define in the games that they offer favor them.

Games of chance, also referred to herein as gambling games, which are the most successful have attributes of fast play, easy winning rules, high odds of winning, and the possibility of large bonus payouts. These attributes are even more important in present times: in this age of the Internet, smart phones, and digital communication, people have short attention spans, limited understanding of probability and statistics, and the expectation of instant gratification. Accordingly, games with these attributes game will attract a large numbers of players and provide a high rate of return to the gaming provider.

Some traditional casino games like craps, and even more simple games like blackjack, require player strategies that are complicated enough to eliminate or discourage many player groups. Younger gamblers prefer more action and higher odds of winning on each bet, with much larger bonus payouts like the “megabucks” style games. There remains an unmet need for new wagering games that have the above attributes, in order to satisfy consumers who are partaking in leisure time activities, and parties who play wagering games for profit.

### SUMMARY

The present invention meets this need by providing gambling games that are fast to play, easy to learn, and have a high likelihood of a winning Player for each play. Additionally, the games may be operated so as to have a large and growing bonus pool for each play. Additionally, certain embodiments of the gambling games offer a sequence of decision points to accept an accrued payout, or risk the payout in further play to obtain an even larger payout. After a first successful wager in such a game, or a series of successful wagers, a Player may be offered the opportunity to accept accrued winnings or decline to accept the accrued winnings and risk the accrued winnings in an additional play of the game.

The games may be played by wagering on the outcome of individual events or sequences of events that occur over a period of time. In some embodiments, the events may be sporting events. Individual sporting events may be, for example and without limitation, a single play in football, pitch in baseball, stroke in golf, or volley in tennis. However, a sporting event upon which a wager may be placed does not necessarily have to be a single play. For the purposes of wagering, an individual event may be a series of downs in football, an inning in baseball, a hole in golf, a set in tennis, or a round in a fight, or the entire game being played. In other embodiments, the event may be a political event, such as the result of an election. In other embodiments, the event may be an event that can be monitored online via the Internet, with a rapid determination of the outcome of the event. Essentially, any indeterminate event that may be tracked and analyzed online in real time to determine an outcome may be an event that can be wagered upon.

In a broad aspect, a game is based on a Player wagering on a series of outcomes of indeterminate events. To begin play, the Player places a wager, betting that a specific outcome of a first event will occur. Play then proceeds with the first event occurring. If the first event occurs with the outcome as specified by the Player, then the Player may be presented with two options:

Option A: Accept a payout of funds from the House based upon the bet that he wagered prior to the first event. The amount of funds paid out depends upon the probability of the outcome of the first event specified by the Player in making his wager. Lower probability outcomes have higher payouts.

Option B: Decide “No Deal,” i.e. decline the above payout of funds, and elect to continue play in an attempt to attain an even greater payout of funds by wagering on an outcome of a second indeterminate event. If the first event was a play or series of plays in a sporting event, the second event may be a play or series of plays in the same sporting event. Alternatively, the second event may be an entirely different event separate from the first event and having no relationship with the first event. In electing this option, the Player risks losing his funds to the House if the outcome of the second event is not the outcome specified by the Player in making the second wager.

Play then proceeds with the second event occurring. If the second event occurs with the outcome as specified by the Player, then the Player may again be presented with two options. In Option A, the Player may accept a payout of funds from the House based upon the bet that he wagered prior to the second event. The amount of funds paid out depends upon the probability of the outcome of the first event specified by the Player and the second event specified by the Player in making his wagers both occurring. In Option B, the Player may again decline the payout of funds, and elect to continue play in an attempt to attain an even greater payout of funds by wagering on an outcome of a third indeterminate event. The wager-and-outcome cycle may continue to be repeated, with payouts to the Player increasing accordingly, based on the probabilities of correctly specifying the sequence of outcomes of the series of indeterminate events.

In certain embodiments, the Option A and Option B choices may not be made available to the Player by the House until a threshold of consecutive winning outcomes is reached by the Player. The Player may be required to specify a sequence or collection of outcomes of multiple events (which may occur simultaneously or in a time sequence) in making a first wager of funds. If any one of the outcomes specified by the Player in his wager does not occur, the Player loses the funds made in his first wager and the game ends. If the Player correctly specifies in his wager all of the outcomes of the multiple events, the cycle of wager-and-outcome may begin, with the payout of funds offered by the House as Option A being a function of the probability of all of the specified outcomes of all of the multiple events of the first wager occurring.

In another aspect of the games, a “bonus pool” may be defined for Players to attempt to win, in addition to the possibility of winning a wager on a single play of the game, or on a sequence of winning plays. The bonus pool may accumulate based on a portion of each Player's bet for all Players engaged in the overall game; and also for all sites where that game is being played. Accordingly, the bonus pool grows with each play in which the bonus is not won. In certain embodiments, the required threshold for winning the bonus pool may be based on attaining a threshold sequence of consecutive winning wagers on plays in the game. In other embodiments, the required threshold may be exceeding an odds threshold for attaining a sequence of consecutive winning wagers.

In another aspect of the games in accordance with the present disclosure, a gaming method is provided. The gaming method may be operated by a business entity (legally incorporated or otherwise), or an individual or groups of individuals, commonly referred to as “the House.”

The gaming method comprises identifying a plurality of N future events as potential wagering events, each one of the plurality of N future events having at least two possible outcomes; for each of the N future events, calculating in real time the probabilities of possible outcomes thereof; for each of the N future events, communicating wagering options on the possible outcomes to a Player; accepting a first wager of funds of a defined value from a Player, the wager specifying a wagered outcome for each one of a plurality of N future events; observing an occurrence of a subset of M future events of the N future events, M being less than N, and determining actual outcomes of the M future events in real time; comparing the actual outcome of the M future events with the wagered outcomes of the M future events specified by the Player; if any one of the actual outcomes of the M future events is not the wagered outcome specified by the Player for that event, transferring the defined value of the wager of funds to the House; and if the actual outcomes of each of the M future events are the wagered outcomes specified by the Player for each of the M future events, offering the Player at least two choices. A first choice is for the Player to accept a first payout of W times the defined value of the funds of the first wager from the House, wherein W is a function of the probability of the actual outcomes of each of the M future events being the wagered outcomes specified by the Player for each of the M future events. A second choice is to wager the funds of the first wager and the first payout on a wagered outcome of an additional one of the remaining events of the N future events.

The gaming method may further comprise, if the Player accepts the first payout, transferring the first payout of funds from the House to the Player; and if the Player wagers the funds of the first wager and the first payout, observing an occurrence of an additional one of the remaining events of the N future events, determining an actual outcome of that one of the remaining events in real time, and comparing the actual outcome of the additional one of the remaining events with the wagered outcome of the additional one of the remaining events specified by the Player. If the actual outcome of the additional one of the remaining events is not the wagered outcome of the additional one of the remaining events specified by the Player, the gaming method further comprises making no first payout from the House to the Player, and transferring the defined value of the first wager of funds to the House. If the actual outcome of the additional one of the remaining events is the wagered outcome of the additional one of the remaining events specified by the Player, the gaming method further comprises offering the Player at least two choices. A first choice is accepting a second payout of X times the defined value of the funds of the first wager from the House, wherein X is a function of the probability of the actual outcomes of each of the M+1 future events being the wagered outcomes specified by the Player for each of the M+1 future events. A second choice is wagering the funds of the first wager and the second payout on a wagered outcome of an additional one of the remaining events of the N future events.

The gaming method may further comprise, if the Player accepts the second payout, transferring the second payout of funds from the House to the Player; if the Player wagers the funds of the first wager and the second payout, observing an occurrence of an additional one of the remaining events of the N future events, and determining an actual outcome of that one of the remaining events in real time; comparing the actual outcome of that additional one of the remaining events with the wagered outcome of that additional one of the remaining events specified by the Player; if the actual outcome of that additional one of the remaining events is not the wagered outcome of that additional one of the remaining events specified by the Player, making no second payout from the House to the Player, and transferring the defined value of the first wager of funds to the House; and if the actual outcome of that additional one of the remaining events is the wagered outcome of that additional one of the remaining events specified by the Player, offering the Player at least two choices. A first choice is accepting a third payout of Y times the defined value of the funds of the first wager from the House, wherein Y is a function of the probability of the actual outcomes of each of the M+2 future events being the wagered outcomes specified by the Player for each of the M+2 future events. A second choice is wagering the funds of the first wager and the third payout on a wagered outcome of an additional one of the remaining events of the N future events.

In general, if the Player does not accept a second payout of X times the defined value of the funds of the first wager from the House, the gaming method may further comprise the Player repeatedly wagering the funds of the first wager plus a multiple of the defined value of the funds of the first wager on a wagered outcome of an additional one of the remaining events specified by the Player, and attaining an additional match of the wagered outcome of that additional one of the remaining events specified by the Player with the actual outcome of that additional one of the remaining events, until all of the remaining future events of the N future events have occurred, and all of the actual outcomes of the N future events match the wagered outcomes of the N future events specified by the Player. In certain embodiments, the gaming method may further comprise paying funds from a bonus pool containing funds incrementally increased in each prior practice of the gaming method in which, for each Player of the gaming method, that Player does not attain a match of wagered outcomes specified by that Player of N future events with the actual outcomes of those N future events.

In certain embodiments, the occurrence of the N future events and the wagering options of the N future events may be viewable on an image display, and the specifying the wagered outcome for each one of the plurality of N future events may be input in real time to a computer via a user interface that is in communication with the computer. In such circumstances, the computer executes an algorithm to analyze input data upon the occurrences of each of the N future events, and determines in real time the outcomes of each of the N future events. The occurrence of a subset of P future events of the N future events may be viewable on an image display, P being less than or equal to M, with the Player first specifying a wagered outcome for each one of the P future events. In such circumstances, the method may further comprise observing the occurrence of the subset of P future events of the N future events in real time, and determining actual outcomes of the P future events in real time; comparing the actual outcome of the P future events with the wagered outcomes of the P future events specified by the Player in real time; and if any one of the actual outcomes of the P future events is not the wagered outcome specified by the Player for that event, transferring the defined value of the wager of funds to the House. In some circumstances, P may be equal to M, and the actual outcomes of each of the M future events are the wagered outcomes specified by the Player for each of the M future events. The Player may be offered the choices of accepting a first payout of W times the defined value of the funds of the first wager from the House, wherein W is a function of the probability of the actual outcomes of each of the M future events being the wagered outcomes specified by the Player for each of the M future events; or wagering the funds of the first wager and the first payout on the wagered outcome of an additional one of the remaining events of the N future events.

The computer may be in communication with a non-transitory storage medium containing archival data predictive of possible outcomes the plurality of N future events. In such circumstances, the computer executes an algorithm to analyze the archival data and calculate in real time the probabilities of the possible outcomes of the plurality of N future events. In certain embodiments, the Player may define at least one of the future events and may also define the specific actual outcome for the at least one future event. The defining the at least one future event and the defining the specific actual outcome for the at least one future event may be input to a computer in real time via a user interface that is in communication with the computer. In such embodiments, the computer may execute an algorithm to calculate in real time the probability of the specific actual outcome for the at least one future event. The computer may further calculate odds for the specific actual outcome for the at least one future event, and communicate the odds to the Player in real time. The Player may then specify a wagered outcome for the at least one future event.

In another aspect of the games in accordance with the present disclosure, a system for a wagering game is provided. The wagering game is operable by a House. The system is comprised of a gaming station, a non-transitory data storage medium, an event data analysis processor, and a master processor. The gaming station is operable by a Player of the wagering game and comprises a display screen viewable by the Player and operable to display a menu of wagering options, and images depicting at least one indeterminate live event, the future outcome of which may be wagered upon by the Player; a user interface including a communication device operable by the Player for placing a first wager of funds on an outcome of at least one indeterminate live event; a communication module receiving real time data on live events, the future outcomes of which may be wagered upon by the Player; and a gaming station processor in communication with the display screen, the user interface, and the communication module, and operable to execute algorithms to communicate live events data and wagering options to the display screen, and to receive wager input from the Player.

The non-transitory data storage medium contains archival data on past events. The event data analysis processor is operable to receive live events input data and execute algorithms to produce live events output data. The master processor is in communication with the gaming station, the data storage medium, and the event data analysis processor and is operable to execute algorithms to analyze archival data, live events output data, gaming station wagering data, and to calculate probabilities of occurrence of outcomes of the at least one indeterminate live event, and to communicate the wagering options based upon the probabilities of occurrence of outcomes of the at least one indeterminate live event to the gaming station in real time.

In certain embodiments, the event data analysis processor may be operable to execute an algorithm to analyze live events output data and determine in real time the outcome of the at least one indeterminate live event upon its occurrence. The event data analysis processor may be operable to execute an algorithm to analyze live events output data and determine in real time a specific length of time before the indeterminate live event begins to occur. In such embodiments, the event data analysis processor may communicate the specific length of time before the indeterminate live event begins to occur to the gaming station processor, and the gaming station processor may communicate a remaining time left to wager on the indeterminate live event to the display screen viewable by the Player.

The live events input data may include at least one of sensor data or live event image data. The actual live events that produce live events input data may include at least one of a sporting event, a political event, or an event monitored by an Internet of Things communication device. The display screen viewable by the Player may be operable to display images depicting a plurality of live events selected by the Player.

The master processor of the system may be operable to execute a virtual game algorithm to analyze input data from the gaming station. The input data may define a virtual team of members selected by the Player, wherein the members of the virtual team are members of actual teams engaged in playing live game events in a competitive sport. The algorithm may further analyze live events output data, and communicate the Player's wagering options to the gaming station for wagering on a next play in a virtual game. The algorithm may further include steps to receive a wager input by the Player at the gaming station on a future outcome, specified by the Player, of at least one additional next play in the virtual game, and to monitor the performance of the members of the virtual team in the live game events in at least one additional next play in actual games that the respective members of the virtual team are playing.

Subsequently, based on the performances of the members of the virtual team in the at least one additional next play in the actual games that the respective members of the virtual team are playing, the algorithm may calculate an outcome of the at least one additional next play in the virtual game, and compare the future outcome specified by the Player of the at least one additional next play in the virtual game with the outcome of the at least one additional next play in the virtual game calculated according to the virtual game algorithm. If the future outcome specified by the Player is not the outcome calculated according to the virtual game algorithm, the algorithm is operable to transfer the wager of funds to the House. The virtual game algorithm further includes steps to determine if the future outcome specified by the Player is the outcome calculated according to the virtual game algorithm, and if true, to offer the Player the choice of accepting a first payout from the House of W times the first wager of funds, wherein W is a function of a probability, calculated according to the virtual game algorithm, of the occurrence of the outcome specified by the Player; or wagering the funds of the first wager and the first payout on a future outcome of an additional next play in the virtual game.

In certain embodiments, the gaming station may be operable to receive input from the Player defining the at least one indeterminate live event and the possible actual outcomes for the at least one indeterminate live event. In such embodiments, one of the gaming station processor or the master processor may be operable to execute an algorithm to calculate the respective probabilities of the possible Player-specified actual outcomes for the at least one indeterminate live event in real time. The algorithm may include steps to calculate a set of odds for the possible Player-specified actual outcomes for the at least one indeterminate live event. The set of odds may be communicated in real time to the Player through the user interface of the gaming station. A Player's wager on a Player-specified actual outcome for the at least one indeterminate live event may be received by the user interface and communicated to the gaming station processor.

In another aspect of the games in accordance with the present disclosure, a system for a “fantasy” wagering game is provided. The wagering game is operable by a House. The system is comprised of a gaming station, a non-transitory data storage medium, an event data analysis processor, and a master processor. The gaming station is operable by a Player of the wagering game and comprises a display screen viewable by the Player and operable to display a menu of wagering options, and images depicting a plurality of live events of a sport; a user interface including a communication device operable by the Player to define a virtual team of members, wherein the members of the virtual team are members of actual teams engaged in playing the live events of the sport, and wherein the communication device is further operable by the Player to place a first wager of funds on an outcome of a virtual play in the sport; a communication module receiving real time data on the live events of the sport, the future outcomes of which may be wagered upon by the Player; and a gaming station processor in communication with the display screen, the user interface, and the communication module, and operable to execute algorithms to communicate data on the plurality of live events of the sport and wagering options to the display screen, and to receive wager input from the Player.

The non-transitory data storage medium contains archival data on past events of the sport. The event data analysis processor is operable to receive live sport events input data and execute algorithms to produce live sport events output data. The master processor is in communication with the gaming station, the data storage medium, and the event data analysis processor and is operable to execute a virtual game algorithm to analyze archival data on past events of the sport, live sport events output data, gaming station wagering data, and to calculate probabilities of occurrence of outcomes of a virtual play based upon outcomes of next plays live events of the sport by members of the virtual team defined by the Player, and to communicate in real time the wagering options based upon the probabilities of occurrence.

The virtual game algorithm may further includes steps to determine if the virtual play outcome specified by the Player is the outcome calculated according to the virtual game algorithm. In circumstances where the virtual play outcome specified by the Player is the outcome calculated according to the virtual game algorithm, the virtual game algorithm further includes the step of offering the Player the choice of accepting a first payout from the House of W times the first wager of funds, wherein W is a function of a probability, calculated according to the virtual game algorithm, of the occurrence of the outcome specified by the Player, or wagering the funds of the first wager and the first payout on a future outcome of an additional next play in the virtual game.

In certain embodiments, the virtual game algorithm further includes the step of defining a list of possible sport play outcomes, calculating probabilities for each possible sport play outcome based on the archival data on past events of the sport, and defining a hierarchy of possible sport play outcomes based upon the calculated probabilities for each possible sport play outcome. The virtual game algorithm may further include the steps of analyzing outcomes of most recent actual plays of members of the actual teams engaged in playing the live events of the sport, and determining a virtual outcome of a virtual play.

In another aspect of the games in accordance with the present disclosure, an additional gaming method is provided. The gaming method is operable by a House using a computer. The method comprises identifying a plurality of actual live sports games being played in real time by actual sports teams and communicating data on the live sports games in real time to a gaming station operable by a Player; accepting by the House input from a Player of the wagering game, the input defining a virtual sports team comprised of members of actual sports teams engaged in playing the live sports games; accepting by the House a first wager of funds on an outcome, specified by the Player, of at least one additional next play in the wagering game; monitoring the individual performances of the members of the virtual team in at least one additional next play in the respective live sports games that the respective members of the virtual team are playing; based on the performances of the members of the virtual team in the at least one additional next play in the respective live sports games that the respective members of the virtual team are playing, executing by the computer a wagering game algorithm to calculate in real time an outcome of the at least one additional next play in the wagering game; comparing the outcome specified by the Player of the at least one additional next play in the wagering game with the outcome of the at least one additional next play in the wagering game calculated according to the wagering game algorithm; and if the outcome specified by the Player is not the outcome calculated according to the wagering game algorithm, transferring the wager of funds to the House.

The gaming method may further comprise determining if the outcome specified by the Player is the outcome calculated according to the virtual game algorithm; and if true, offering the Player the choice of accepting a first payout from the House of W times the first wager of funds, wherein W is a function of a probability, calculated according to the virtual game algorithm, of the occurrence of the outcome specified by the Player; or wagering the funds of the first wager and the first payout on the outcome of an additional next play in the virtual game.

The gaming method may further comprise defining a list of possible game play outcomes, calculating probabilities and odds for each possible game play outcome, and defining a hierarchy of possible game play outcomes based upon the calculated probabilities and odds for each possible game play outcome.

The gaming method may further comprise defining a play analysis algorithm executable by the computer and operable to analyze outcomes of previous plays of members of the actual teams engaged in playing the live game events, and calculate a “virtual outcome” of a virtual play.

In another aspect of the games in accordance with the present disclosure, an additional gaming method is provided. In the gaming method a Player specifies the event and outcome upon which he wishes to wager. A computer calculates the odds of the Player-specified outcome, and offers the Player the opportunity to make a wager at the calculated odds.

More specifically, the gaming method comprises receiving input from a Player to the computer via a gaming station operated by the Player, the input identifying a specified future indeterminate event, and a specified possible outcome of the specified future indeterminate event; communicating to the computer archival input data from a non-transitory data storage medium on past events relevant to possible outcomes of the specified future indeterminate event; communicating to the computer live input data from at least one of a sensor or an imaging device acquiring the live input data at the future indeterminate event; executing by the computer an algorithm to calculate the probability of the specified possible outcome of the specified future indeterminate event, and odds for the specified possible outcome of the specified future indeterminate event; communicating the odds to the Player via the gaming station; receiving from the Player to the computer via the gaming station, a first wager of funds of a defined value from a Player, the wager being that the specified possible outcome of the specified future indeterminate event will occur; communicating to the computer live input data from the at least one sensor or imaging device in real time indicative of the actual outcome of the specified future indeterminate event; comparing by the computer the actual outcome of the specified future indeterminate event with the specified possible outcome defined by the Player; and if the actual outcome of the specified future indeterminate event is not the specified possible outcome defined by the Player, transferring the defined value of the wager of funds to the House.

In certain embodiments, wherein if the actual outcome of the specified future indeterminate event is the specified possible outcome defined by the Player, the gaming method further comprises making a payout to the Player of W times the defined value of the funds of the first wager from the House, wherein W is a function of the probability calculated via the algorithm of the actual outcome of the specified future indeterminate event being the specified possible outcome defined by the Player.

In other embodiments wherein if the actual outcome of the specified future indeterminate event is the specified possible outcome defined by the Player, the gaming method may comprise offering the Player the choice of accepting a first payout of W times the defined value of the funds of the first wager from the House, wherein W is a function of the probability calculated via the algorithm of the actual outcome of the specified future indeterminate event being the specified possible outcome defined by the Player; or wagering the funds of the first wager and the first payout on a wagered outcome of an additional future indeterminate event.

The specified future indeterminate event may be, without limitation, a sporting event, an election or political event, or an event observed by an Internet of Things sensor or image capture device.

### BRIEF DESCRIPTION OF THE DRAWINGS

The present disclosure will be provided with reference to the following drawings, in which like numerals refer to like elements, and in which:

FIG. 1 is block diagram of a system for operating wagering games of the present disclosure;

FIG. 2 is a schematic illustration of an image display screen of a gaming station of the present disclosure;

FIG. 3 is an illustration of an exemplary portion of the display screen of FIG. 2, depicting the presentation of wagering options and the televising of a sporting event that a Player can wager upon;

FIG. 4 is a flowchart depicting the play of a wagering game using the system of FIG. 1; and the display of FIGS. 2 and 3, from the perspective of the House;

FIG. 5 is a flowchart depicting certain embodiments of wagering games of the present disclosure in a generalized manner, from the perspective of a Player;

and

FIG. 6 is a flowchart depicting the play of a “fantasy sport” wagering game.

The present invention will be described in connection with certain embodiments. However, it is to be understood that there is no intent to limit the invention to the embodiments described. On the contrary, the intent is to cover all alternatives, modifications, and equivalents as may be included within the spirit and scope of the invention as defined by the appended claims.

### DETAILED DESCRIPTION

For a general understanding of the present invention, reference is made to the drawings. In the drawings, like reference numerals have been used throughout to designate identical elements. The drawings are to be considered exemplary, and are for purposes of illustration only. In any drawings and related disclosure that depict methods of the present invention, the steps may vary from the order depicted, certain steps may be eliminated, and/or certain steps may be added, unless expressly stated otherwise.

As used herein, the term “plurality” is meant to indicate “at least two.” Thus a “plurality of future events” is meant to indicate “at least two future events,” and may indicate three, four, five, etc. or more future events.

As used herein, “virtual” is used with reference to an object, a collection of objects, an individual person, a collection of persons as a team, a space defined by boundaries, or an action or step of a method that is/are not physically existing (referring to objects or persons), or occurring in a physical location (referring to an action), but instead is/are simulated by a computer for observation, wagering, or other use by an observer.

As used herein, an “indeterminate event” is an event that will occur in the future (and in some cases, the immediate future, e.g., within seconds or minutes), with the outcome of the event being unknown until the event occurs. An indeterminate event has at least two possible outcomes, and possibly more outcomes. The respective probabilities of the possible outcomes of an indeterminate event may be equal, but often will be unequal.

The games of chance disclosed herein may be played by a Player on a gaming station at physical locations, such as casinos or clubs, or in homes. In some embodiments, such as casino embodiments, the gaming stations may be provided for the sole use of playing the games. In other embodiments, such as when a Player is located in his home or other non-casino location, the Player may play a game on his personal computer, tablet computer, smart phone, or other mobile communication device, which may execute computer applications for functioning as a gaming station. Multiple parties may play the games simultaneously at a physical location such as a casino, or from individual remote locations. The multiple parties may play the games using separate computers, tablets, smart phones, or other mobile communication devices that may be networked and in communication with each other.

In a broadly characterized embodiment of the wagering game, the game is operated by a business entity (legally incorporated or otherwise), commonly referred to colloquially as “the House.” In such circumstances, a wagering party, who is playing the game, has an interest adverse to the House, i.e. the Player is playing the game to win money from the House, and the House is offering the game to the wagering party with the objective of keeping the money bet by the Player, or at least on average, to operate the game so as to take in more money bet by losing Players than it pays out to winning Players. (It is noted that the terms “Player” and “Wagerer” are used interchangeably in this disclosure.) The game may be played with multiple wagering parties, i.e., Players, pitted against the House. As will be explained subsequently, payouts to Players are correlated with the probability of certain outcomes occurring when playing the game, and are set at levels so as to enable the House to achieve its “on average” objective of earning money over a period of time.

In another broadly characterized embodiment of the wagering game, the game is implemented on one or more computers. A first computer is provided as a gaming station, which may be embodied in a personal computer, tablet computer, a smart phone, a smart watch, or another communication device, which contains an executable program that enables a Player to play the game though a user interface that is in communication with the computer. The user interface may include an image display and an input device such as a mouse, joystick, keyboard, motion/acceleration activated device, and/or voice-activated device; or the display may be a touch screen display that receives input from the user, as well as displaying aspects of the game to the user.

The computer-implemented embodiment of the game may be played simultaneously by more than one Player, each of the respective Players playing the game on a gaming station. The gaming station(s) function on behalf of the “House,” and in embodiments of the game played in a casino, may be owned by the House. The display of the gaming station provided to the user may be an image screen, i.e., a standard flat screen displaying images, or in the form of display screens fittable proximate to the eyes of the party, sometimes referred to as “virtual reality” glasses or a virtual reality headset.

In playing the game, the Player places one or more bets of funds of a defined value against the House. The funds may be physical money, i.e., coins or currency, or some physical object equated with money such as a casino chip, or the funds may be transacted electronically via a credit or debit card and/or wirelessly using a smart phone or other mobile device. The funds may be proffered in digital form, such as bitcoin or another cryptocurrency.

In circumstances where the outcome of the game is in favor of the House, the Player loses the bet(s), and the House keeps the funds wagered by the Player. In certain embodiments, a predetermined portion of all Player losses are incrementally added to a “bonus pool” from each physical or virtual location and Player playing the game at that time. The bonus pool may increment at all physical and virtual locations, and may be shown at each location before the next play of the game.

In circumstances where the outcome of the game is in favor of the Player (a “winning” outcome), the House returns the bet of funds to the Player, and further pays out additional funds to the Player. In general, the amount of additional funds depends upon the probability(s) of the occurrence(s) of particular outcome(s) (commonly refer to as “odds”) of one or more events that are wagered upon by the Player. Additionally, in playing the game, a Player wagers on the outcome of an indeterminate event. In some circumstances, the possible outcomes of a particular event may be known in advance, e.g., the possible outcomes may be limited to outcomes A, B, and C. Additionally, the respective probabilities of occurrence of outcomes A, B, and C may be known in advance, and thus the possible payouts of funds to the Player for a winning wager will also be known in advance of the Player beginning the game.

In other circumstances, a particular event may have a broad range of discrete outcomes, or a continuum of outcomes. For example, a professional golfer may be able to drive a golf ball between about 280 and 350 yards. If one were to wager on the length of the golfer's next drive, the outcome could be any number within that range (or even below the range since it is possible for the golfer to drive the ball badly).

Additionally, the probability of a specific outcome in a particular event to be wagered upon may not be known well in advance of the event. The probability may depend upon what happened before the particular event, i.e. the probability may depend upon the outcome of a preceding event, or upon the outcomes of a sequence of preceding events. In one aspect of the present disclosure, the probability of a specific outcome of a particular event may be calculated in real time based upon incoming data from one or more data sources. The incoming data may include data on the outcomes of preceding events, including events that happen just minutes or seconds before the particular event to be wagered upon. In such circumstances, for the possible outcomes of the particular event to be wagered upon, the odds for the particular outcomes may be calculated in real time and presented to a Player for his consideration in making a wager. In accordance with the present disclosure, recent advances in image processing, data acquisition, wireless communications, computer memory, and computer processors are applied in new ways to provide the capability to calculate probabilities of event outcomes in real time.

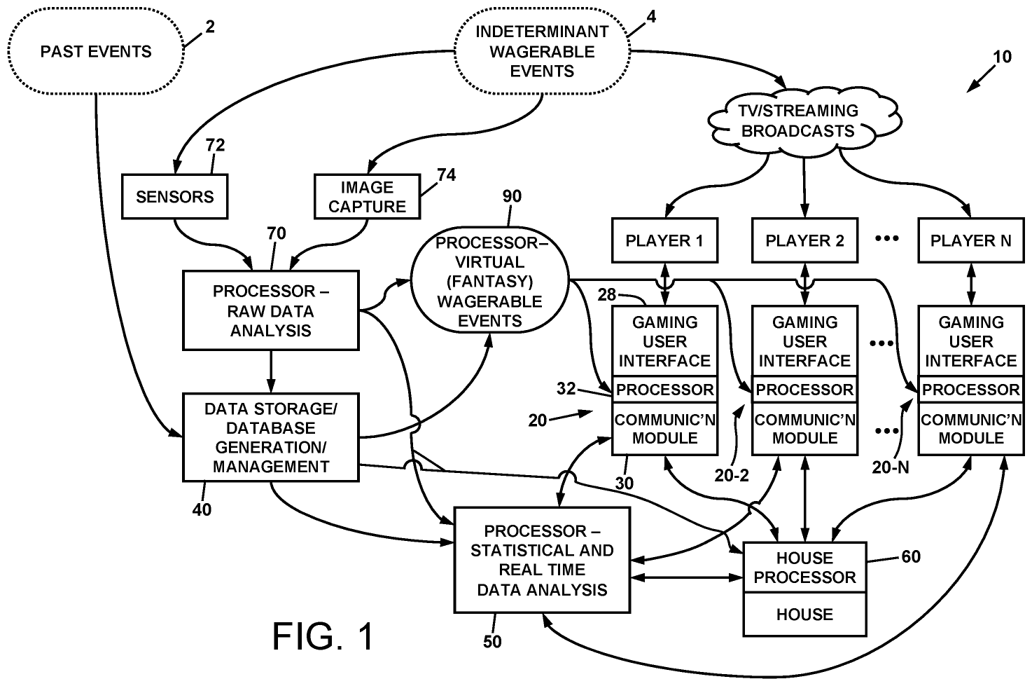

To further illustrate the above generalized disclosure of the games, as well as more specific embodiments, reference is made to FIGS. 1-6. Referring first to FIG. 1, a block diagram of a system for operating wagering games of the present disclosure is presented. The wagering games are operable by a House. The system includes various components and sub-systems, the inclusion of which depends upon the particular type of game being played, the location of the House, the location of the Player(s), and whether multiple players are engaged in play of the game.

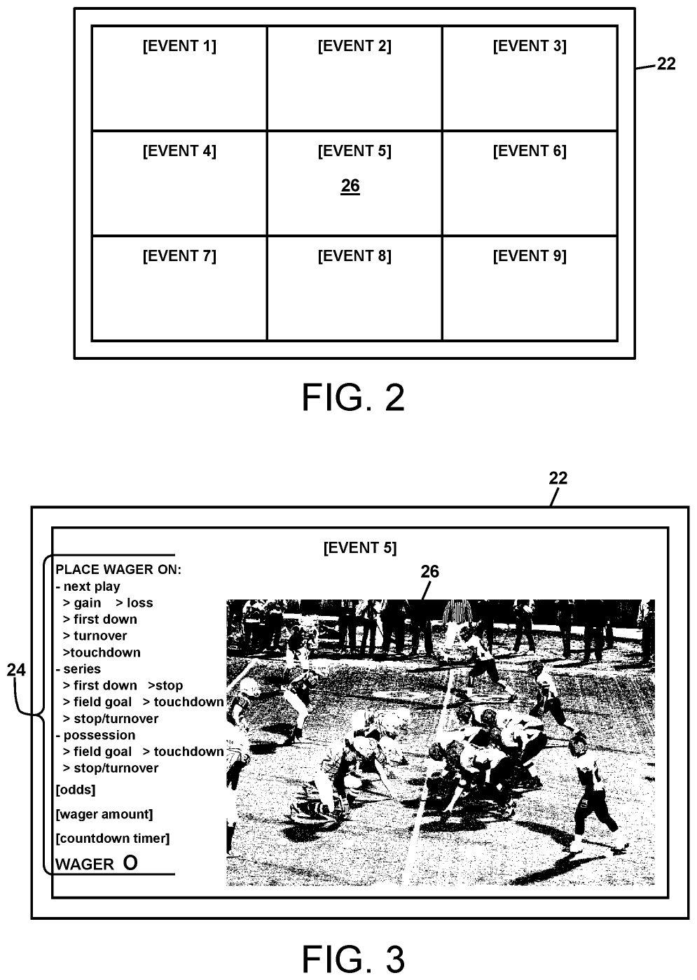

The system 10 is comprised of a gaming station 20, a non-transitory data storage medium 40, a peripheral processor 50, and a master processor 60. The gaming station 20 is operable by a Player (not shown) of the wagering game and comprises a display screen 22 (FIGS. 2 and 3), a user interface 28, a communication module 30, and a gaming station processor 32. The display screen 22 is viewable by the Player and operable to display a menu 24 of wagering options, and images 26 depicting at least one live event, the future outcome of which may be wagered upon by the Player. The user interface 28 includes a communication device operable by the Player for placing a first wager of funds. The communication module 30 is operable to receive data on live events, the future outcomes of which may be wagered upon by the Player. The gaming station processor 32 is in communication with the display screen 22, the user interface 28, and the communication module 30, and is operable to execute algorithms to communicate live events data and wagering options to the display screen 22, and to receive wager input from the Player.

The non-transitory data storage medium 40 contains a database that includes archival data on past events 2 that have occurred. The data storage medium 40 may also receive data that is acquired from observation and/or measurement of indeterminate wagerable events 4. The system 10 may include sensors 72 and image capture devices 74, such as still motion or video cameras. The system may further include a data analysis processor 70, which receives sensor input data and image data. The data analysis processor 70 may be programmed to execute algorithms to analyze the sensor and/or image data, and produce live event output data, which may be exported to the non-transitory data storage medium 40, and/or to the peripheral processor 50 and/or to the master processor 60.

The peripheral processor 50 may also receive live events input data from the data analysis processor 70, or directly from the sensors 72 and/or imaging devices 74, and execute algorithms to produce live events output data, all occurring in real time. The peripheral processor 50 may be programmed to execute algorithms to analyze both archival data on past events in combination with live event output data, which is produced in real time prior to or while an indeterminate wagerable event occurs.

(As used herein, for certain embodiments, “real time” means on a time scale of the order of no more than a few seconds, and preferably less than one second, such that the data is available for analysis, calculation of event probabilities and odds, and presentation of such information to a Player at the gaming station 20, so that the Player does not perceive any significant delay for information to be presented to him in order to make a wagering decision. Additionally, “real time” means on a relatively short time scale, as compared to the time scale of the indeterminate event being wagered upon. For example, if a Player is betting upon the outcome of plays in an American football game, and the typical time to execute a play, re-spot the football, line up and start the next play is about one minute, then it is preferable that “real time” acquisition and analysis of event data and presentation of wagering options to a Player would occur on a time scale of no more than a few seconds, so that the Player has sufficient time to consider the wagering options and input his wager before a cutoff timer closed the opportunity to wager. For slower-paced sports, such as golf, the “real time” requirements could be somewhat slower. Accordingly, for individual operations such collecting live event data; communicating live event data to the data analysis processor 70; executing live event data analysis algorithms; communicating live event output data to the peripheral processor and/or the master processor; executing algorithms to analyze archival data, live events output data, gaming station wagering data, and to calculate probabilities of occurrence of outcomes of the live event; and communicating wagering options to the gaming station for consideration by the Player, “real time” execution of these operations must be done on shorter time scales. By using high speed communication protocols, such as 5G, and high speed processors such as those used in computer graphics and cryptocurrency mining (e.g. the Nvidia GeForce GTX 1070 graphics processor), the real time processing and communication requirements of games of the present disclosure are enabled.)

The master or house processor 60 is in communication with the gaming station 20, the data storage medium 40, and the peripheral processor 50, and the processors are operable to execute algorithms to analyze archival data, live events output data, and gaming station wagering data, and to calculate probabilities for various outcomes of indeterminate wagerable events. The algorithms may include calculating odds for the outcomes of indeterminate wagerable events. The House processor 60 or peripheral processor 50 communicates the wagering options to the gaming station 20 for consideration by a Player. In general, the odds for a particular outcome are approximately inversely proportional to the probability of that outcome occurring, but include an adjustment such that, on average, the House takes in more money on losses by Players than it pays out to wins by Players.

It is to be understood that while the gaming system 10 is described as having separate master, peripheral, and data analysis processors 60, 50, and 70, that other system configurations may be suitable. For example, a single processor may be provided which operates the algorithms for the master and peripheral processors 60 and 50, or all three processors. Additionally, the data storage medium may be on a remotely located server, such as a cloud server, and the processors may also be remotely located, i.e., performing “cloud computing.” The House processor 60 may be located onsite at a facility of the House, i.e., while the peripheral, and data analysis processors 50 and 70 are located remotely. In certain embodiments, the functions of the peripheral and data analysis processors 50 and 70 may be performed by a single event data analysis processor or central computer. The overall choice of system architecture may be driven at least in part by what is the optimal configuration for having sufficient communication speeds to and from a Player in “real time” as described above. In general, the occurrence of future events and the wagering options of the future events may be viewable on an image display, and the specifying the wagered outcome for each one of the plurality of future events may be input in real time to a computer via a user interface that is in communication with the computer. In such circumstances, the computer executes an algorithm to analyze input data upon the occurrences of each of the future events, and determines in real time the outcomes of each of the future events.

It is also to be understood that the gaming station 20 may be a dedicated gaming station owned by the House and located in House property, e.g., at a casino, in a manner similar to other types of gaming stations being located in a casino. Alternatively, the gaming station 20 may be a personal computer, tablet computer, smart phone, or other mobile communication device, which may owned by the Player, and may be programmed with computer applications for functioning as a gaming station. Multiple parties may play the game simultaneously on gaming stations 20-2 through 20-N (FIG. 1) at a physical location such as a casino, or from individual remote locations. The multiple parties may play the games using separate computers, tablets, smart phones, or other mobile communication devices that may be networked and in communication with each other.

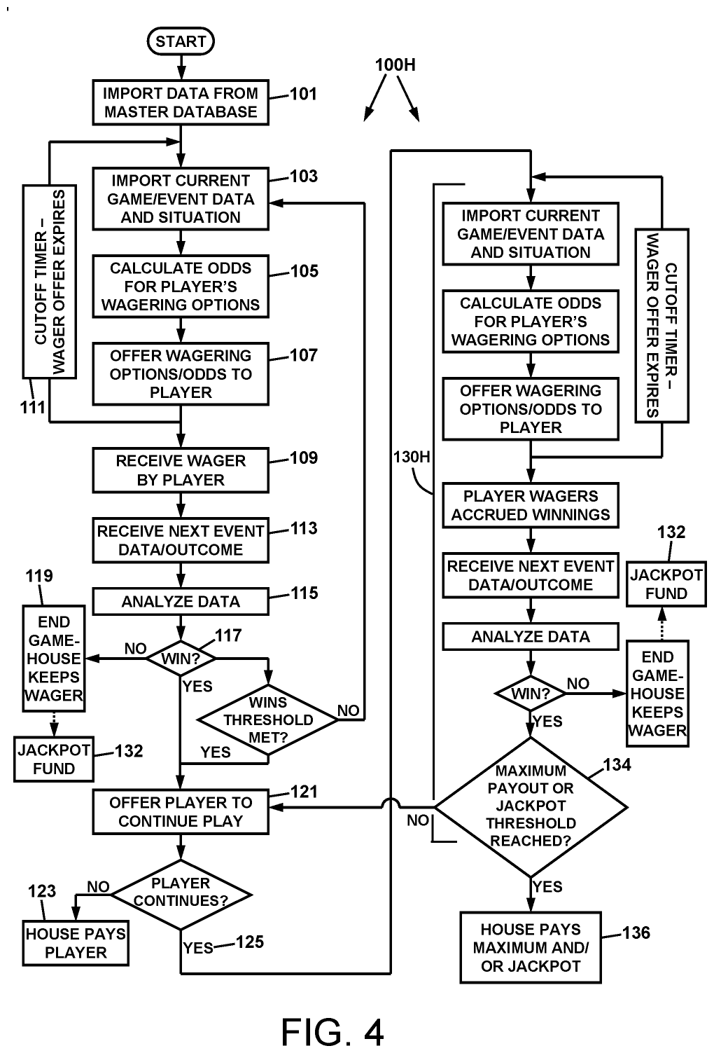

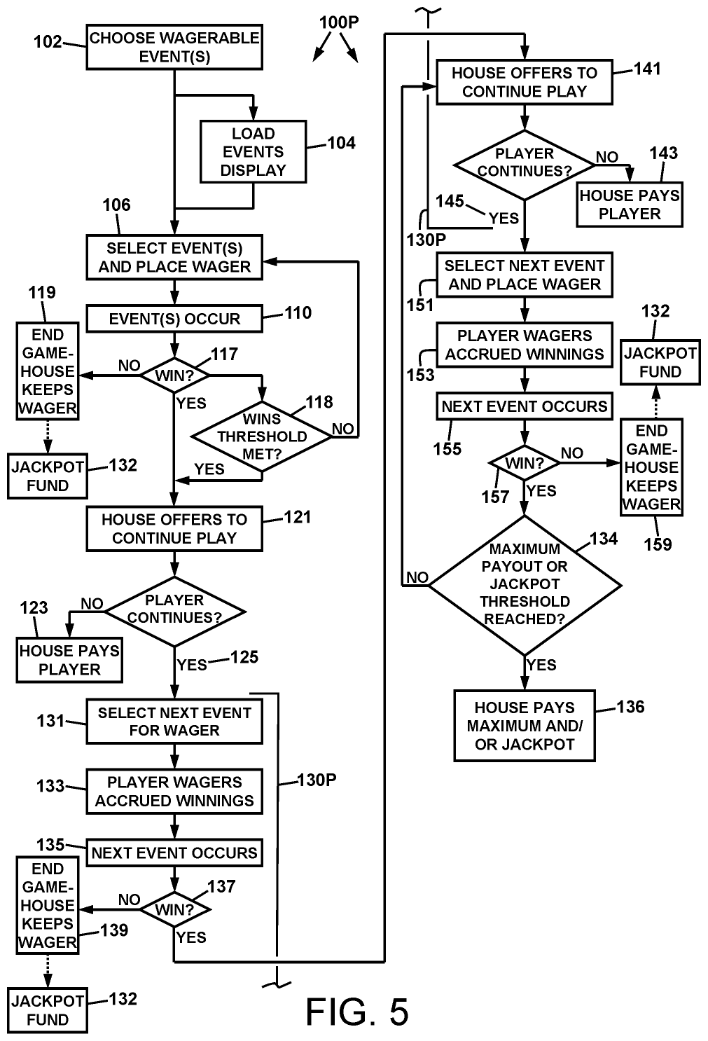

Certain gaming methods may be practiced using the system 10 of FIG. 1. Such gaming methods will now be described with reference to FIG. 4, which is a flowchart depicting the play of a wagering game from the perspective of the House, and FIG. 5, which is a flowchart depicting certain wagering games from the perspective of a Player.

Referring to FIG. 4, and in the method 100H depicted from the perspective of the House, the House chooses to offer opportunities to wager on a variety of indeterminate events 4. The indeterminate events 4 may be occurring simultaneously, or over a short span of time, i.e., on the same day. For each of the indeterminate events 4, the peripheral processor 50 imports 101 relevant data from the database in the data storage medium 40. Such data may be based on past events, and for a sporting event that is an example of the indeterminate event 4, the data may include statistics on the teams that are playing, and on individual players in the sporting event.

The peripheral processor 50 also imports 103 data collected in real time from observation and/or measurement of the indeterminate event 4. For sporting events, sensors 72 and cameras 74 acquire sporting event data, which are analyzed by the data analysis processor 70. The sensors 72 may include weather sensors that detect temperature, wind speed, precipitation, and the like. The sensors 72 may be sensors in a game ball (such as a football), or sensors worn by the players of the game. By way of example, in professional football, players may be wearing RFID tags which track real-time location coordinates on players. Such RFID tags are manufactured and sold by the Zebra Technologies Corporation of Lincolnshire, Ill. under the Zebra MotionWorks™ brand. Acquisition of sporting event and player data is also disclosed in, e.g., U.S. Pat. No. 9,985,672 of Wohl et al., and U.S. Pat. No. 9,602,152 of Wohl et al., the disclosures of which are incorporated herein by reference. In professional baseball, the Trackman Baseball software and sensor system, manufactured and sold by TrackMan, Inc. of Stamford, Conn. is used to acquire event data in real time. The system uses 3D Doppler radar paired with video image acquisition, as disclosed in U.S. Pat. No. 9,855,481 of Tuxen et al., the disclosure of which is incorporated herein by reference. Similar systems have been developed and are in use in professional tennis, golf, auto racing, and many other sports, thereby producing real-time data that may be imported and analyzed for the purpose of offering wagering choices to Players of a wagering game. In certain embodiments, the data that is imported from a third party provider, e.g., a provider of real time data in professional baseball, football, golf, basketball, etc., may contain data that defines the outcome of a play, a series of plays, or a shot or series of shots.

The peripheral processor 50 may also import 103 data collected in real time from observation and/or measurement of non-sporting indeterminate events 4. In other embodiments, the indeterminate event 4 may be an event that can be monitored online via the Internet, with a rapid determination of the outcome of the event. Essentially, any indeterminate event that may be tracked and analyzed online in real time to determine an outcome may be an event that can be wagered upon. With the proliferation of the “Internet of Things,” there is now a huge supply of indeterminate events that may be measured and/or observed, and wagered upon by a Player. While some indeterminate events may seem trivial, advantageously, the ability of a Player to wager upon them adds entertainment value to the game.

Turning to the Player's perspective of the game as shown in FIG. 5, and also referring to FIGS. 1-3, when the Player accesses a gaming station 20, he may be presented with a list of possible indeterminate events upon which wagers may be placed. In a first step of the method 100P, the Player may choose 102 a set of events upon which he may wish to place wagers. The events may be presented 104 in an array on the gaming station display screen 22 as shown in FIG. 2. The Player may select 106 a particular event that he may decide to wager upon. In the example in FIG. 3, the Player has selected EVENT 5. The exemplary display screen 22 in FIG. 2 that is presenting a choice of nine events may be a touch screen, such that when the player touches the image 26 of EVENT 5, the result is the screen display of FIG. 3. In the example in FIG. 3, the image 26 that is displayed is a football game. Adjacent to the image is a menu of exemplary wagering choices, from which the Player may select a parameter to wager upon in the football game event.

Meanwhile, referring to FIG. 4, the peripheral processor 50 has continued to import 103 data collected in real time from observation and/or measurement of the nine sporting events that the Player has selected for possible wagering. The peripheral processor calculates 105 probabilities and odds for a variety of wagering choices that may be offered 107 to the Player for consideration. The odds are communicated by the peripheral processor 50 to the House processor 60, and may also be communicated directly to the gaming station 20; or the House processor 60 may communicate the odds to the gaming station 20.

In either case, in the example presented in FIG. 3, the Player has selected EVENT 5 upon which to place a wager. If the event is a football game as shown in FIG. 3, the Player may wager on a variety of outcomes of the next play, including but not limited to the play resulting in a gain or loss, a first down, a turnover, a touchdown. The Player may also wager upon a variety of outcomes of the ensuing series of downs, including a first down, a defensive stop, a field goal, a touchdown, or a turnover. The Player may also wager upon a variety of outcomes of that possession of the football by the team, including a field goal, a touchdown, a defensive stop, or a turnover. For any of these choices, the Player is presented with odds for the respective outcomes. The odds are calculated in real time by the peripheral processor 50, based upon the combination of archival data on past events, and real time data acquired on the sporting event as it has occurred up to that point.

Via the gaming station user interface 28, which may have touch screen functionality integrated into the display 22, or a keyboard, or other suitable input device, the Player inputs 109 his wager on the outcome of the next play, series of downs, or possession that he has chosen. While the Player is considering his options to wager, a cutoff timer 111 is present and counting down on the display screen. The peripheral processor 50 is monitoring the progress of the football game via the algorithm programmed therein. The algorithm determines a point in time where the beginning of the next play, series of downs, or possession is imminent, and thus sets a final time for the Player to enter his wager on the next play, series of downs, or possession. If the Player does not input 109 his wager before the cutoff timer 111 reaches zero, then the offer to wager on that next play, series of downs, or possession is withdrawn.

In some types of games or situations, there may be uncertainty as to the exact time when a next play will occur, and thus a cutoff timer may not be effective at setting an exact time after which a wager cannot be placed. Instead, the wager cutoff time may be determined by an algorithm, based on knowledge of how soon a play will occur in the game. For example, when a batter steps into the batter's box, it is known that the next pitch (i.e., a play) is imminent. Likewise, when a golfer tees up his ball, a golf shot is imminent; and when linemen line up at the line of scrimmage, a football play is imminent. Referring to FIG. 1, real time data from sensors 72 worn by the player(s), or from sensors 72 proximate to the players, or digital image data from cameras 74 may be input to the data analysis processor 70, which in turn communicates output data to the peripheral processor 50. The peripheral processor 50 executes the algorithm in which a cutoff time for placing a wager is determined, and communicates the cutoff time to the gaming station 20. The display of the gaming station may present a simple indicium such as a green light indicating that a wager may be placed, a yellow light indicating that just a short time (e.g., five seconds), or a red light indicating that the opportunity to wager on the next play is closed.

If the Player misses the opportunity to wager on a given play, the algorithm recalculates probabilities and odds for the next play, series of downs, or possession, and offers updated wagering options to the Player with a new cutoff timer counting down (or the cutoff algorithm is reset, and analysis new sensor and/or image data relevant to the onset of the next play begins. Alternatively, the Player may make an input to recall his choices of events (e.g., the nine events shown in FIG. 2), which are restored to the display 22. The Player may then select a different event to wager upon.

With the Player's wager made in sufficient advance of the indeterminate event 4, the event 4 occurs 110. The data analysis processor 70 receives 113 data on the event 4. The data analysis processor 70 stores the data in the database contained in the data storage medium 40 as archival data on past events. More importantly, the data analysis processor 70 analyzes 115 the data on the event 4, and determines the actual outcome of the event 4. In certain embodiments, as described previously, if the data is from a third party provider, it may already contain data that defines the outcome of a play, a series of plays, or a shot or series of shots. In other embodiments, the data analysis processor 70 is operable to execute an algorithm that analyzes sensor and/or image data, and determines the outcome of the event being wagered upon by the Player. The data analysis processor 70 communicates the outcome of the event 4 to the house processor 60. The house processor 60 then compares 117 the actual outcome of the event 4 with the outcome specified by the Player in his wager.

If the actual outcome of the event 4 is not the wagered outcome specified by the Player for that event, the game ends 119, and the House transfers the wager of funds to the House, i.e., the House keeps the Player's wager. If the actual outcome of the event 4 is the wagered outcome specified by the Player, the Player is offered 121 two choices. A first choice is for the Player to accept a first payout 123 of W times the defined value of the funds of the first wager from the House, wherein W is a function of the probability of the actual outcomes of the event 4 being the wagered outcome specified by the Player for the event 4. A second choice is for the Player to continue play 125, wagering the funds of the first wager and the first payout on a wagered outcome of an additional indeterminate event 4. Playing of the game may then continue, with repeated cycles 130H and 130P occurring from the standpoint of the House and Player, respectively, for as long as the Player continues to attain winning outcomes.

Referring again to FIGS. 4 and 5, in certain embodiments of the game 100H/100P, the House rules may stipulate that for the Player to have the option to continue play in pursuit of a higher level of payout, the number of winning wagers must exceed a certain threshold, which is checked at gate 118. In a parlay-type wagering arrangement, the House rules may require that a minimum number of events must be wagered upon before the House begins to offer the “Option A” and Option B” choices.

In certain embodiments of the gaming method, the Player may define one or more of the indeterminate future events to be wagered upon and may also define a specific actual outcome for the future event(s) that he wishes to wager will occur. In other words, the Player may play the game by wagering upon any indeterminate event 4 that he wants to, if data on that event can be acquired in real time on the event 4, and the analysis of the data can be done to determine the actual outcome of the event in real time.

Referring to FIG. 5, instead of selecting 106 an event 4 to wager upon from a House-generated menu as described previously, the Player defines the indeterminate future event 4 and the specific outcome upon which he wishes to wager will occur. At the gaming station 20, via the user interface 22, the Player enters a short text description of the indeterminate future event, and the specific outcome that he wishes to wager will occur. For example, if the Player is observing a baseball game on his gaming station 20, and Bill Smith is coming up to bat, the Player may enter “Bill Smith to strike out,” either as typed text, or vocally. If the Player is observing a golf tournament, the Player may enter, “John Doe's next drive into the rough,” or “Bob Jones' approach shot within ten feet of the pin.” Either the House processor 60 or the peripheral processor 50 is programmed with an algorithm that includes voice and/or text recognition, and further includes an “AI” (artificial intelligence) algorithm to interpret and determine the meaning of the Player's event and outcome specification in the context of the game being played. If the algorithm of the House processor 60 or the peripheral processor 50 is unable to recognize the Player's input description of the indeterminate future event 4 and the specific outcome upon which he wishes to wager, the processor 50 or 60 provides a response message to that effect, and requests that the Player input another choice of event for wagering.

With the meaning and wagered outcome being determined by the processor 50 or 60, the peripheral processor 50 accesses the data storage medium 40 and imports archival data relevant to the performance of the player in the sporting event from the database 40. Such archival data may include the player's performance in previous sporting events, his previous performance in that sporting event, and other players' performances in previous and present sporting events. The peripheral processor 50 may also obtain real time data from the data analysis processor 70 on that sporting event, which in turn may have acquired such data from the sensors 72 and image capture devices 74.

By way of example, for a golf event in which the Player specifies, “Bob Jones' approach shot within ten feet of the pin,” the peripheral processor 50 may obtain past event data on Jones' recent tournament play, his play on the present golf course, his play on the particular golf hole being played, and his play in the present round so far, as well as the play of other golfers on the present golf course and hole being played. The peripheral processor 50 may also obtain real time data from sensors of current conditions on the golf course, such as wind speed, “speed” of the greens, location of the pin, and the like. The algorithm in the peripheral processor 50 analyzes all of the acquired past data, and present real time data, and calculates the probability of Jones hitting his next shot within ten feet of the pin, as specified by the Player. Additionally, the algorithm in the peripheral processor 50 may calculate the odds of Jones hitting his next shot within ten feet of the pin, e.g., 10:1 odds that Jones will NOT be within ten feet of the pin; or the peripheral processor 50 may communicate the probability to the House processor 60, and the House processor 60 may calculate the odds. In either case, a factor is added in converting the base probability to odds, such that on average over time, the House takes in more funds from losses by Players than it pays out for wins by Players as described previously.

The analysis of the Player's specified event and outcome are done in real time in a matter of seconds after the Player's specified event and outcome are entered at the gaming station, such that in seconds after entry, the Player is offered odds by the House for wagering on his specified event and outcome. As per the above example, after the Player enters “Jones' approach shot within ten feet of the pin,” within seconds, the gaming station display offers “10:1” in an ODDS field on the display. The Player may then choose to wager funds, such that if Jones shot is within 10 feet of the pin, the House will pay $10 for every $1 wagered by the Player. (However, the calculated probability of Jones' shot being within 10 feet of the pin might be 8 percent, or 0.08, with a 92% probability of not being within 10 feet of the pin. Thus by offering 10:1 odds, and performing a similar practice on other Players' wagers, the House will gain a profit on average over all wagers.)

The indeterminate events and outcomes that may be specified by a Player are not limited to sporting events. The events may be, for example, political events (“candidate Johnson to win election,” or “candidate Johnson to receive less than 45% of the vote,”), or an event monitored by an Internet of Things communication device, and in particular, a device whose data is accessible online to the general public. Such data may include, e.g., weather event data, traffic data, imaging data from satellites and space telescopes, and the like. If a Player inputs an indeterminate event and outcome that he wishes to wager upon, and the algorithms of the data analysis processor 70, peripheral processor 50 or House processor 60 are unable to recognize the event or are unable to analyze acquired data on the event and determine its outcome, the House processor will communicate to the gaming station 20, declining to accept a wager on the indeterminate event identified by the Player.

The ability of Players to specify events and outcomes that they want to wager upon, rather than have the House define a limited menu of events and outcomes for wagering, is advantageous. Such dynamic capabilities are enabled by the integration of real time data processing of archival and present event data and the artificial intelligence algorithms, and the ability to present wagering options immediately to player-specified events. Such dynamic capabilities make the games of the present disclosure more exciting, fun, and interesting to play, thereby attracting more Players to participate in the games.

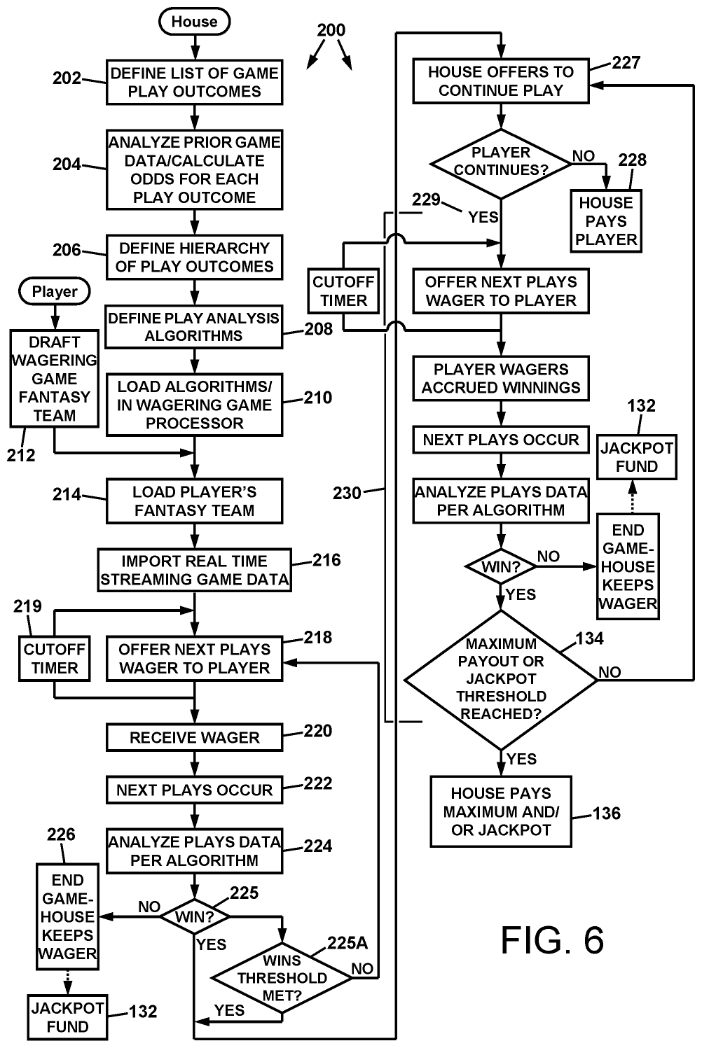

Another gaming method that may be played with the gaming system 10 of FIG. 1 will now be described with reference to FIG. 6, which is a flowchart depicting the play of the alternative wagering game from the perspective of the House. In general, the gaming method is directed to a “fantasy sports” game. The gaming method is operable by a House based upon actual sports games played by actual teams in a sports league. The game as played according to the gaming method may be played over very short time intervals, even on a play-by-play basis as plays occur in actual sports games, rather that based on the outcomes of entire games and/or the performances of players who are playing the actual sports games.

The gaming method 200 comprises a series of initial steps that may be performed by the House, prior to a Player engaging in play of the game. In a first step, a list of possible game play outcomes is defined 202. Using American football as an example, game play outcomes may include, but are not limited to, a touchdown, a field goal, a safety, an incomplete pass, a completed pass resulting in yardage gained (at various yardage lengths), a running play resulting in yardage gained (at various yardage lengths), a fumble, an interception, a punt, a kickoff, and other outcomes not listed here.

Some sport play outcomes are more uncommon than others. In general, the plays generating the most excitement for fans are the most significant plays, such as touchdowns, interceptions, and pass plays that gain large amounts of yardage. In an additional step, prior sporting event game data, which may be contained in a database in data storage medium 40, may be analyzed 204 by the data analysis processor 70. The processor 70 executes an algorithm that determines the probabilities of a broad range of outcomes of the football plays. A hierarchy of play outcomes is then defined 206: the lower the probability of a particular play outcome, the higher it is ranked or weighted in an ordered list of play outcomes.

Play analysis algorithms are then defined 208. The algorithms analyze the outcomes of the most recent plays of players engaged in the football games that are occurring at that particular time, and calculate a “virtual outcome” of a virtual play. In certain embodiments, the virtual outcome is the highest-ranked outcome of a most recent actual play. In other embodiments, the virtual outcome may be a weighted average of outcomes of the most recent actual plays. Over the course of play in the wagering game, the Player can wager on the virtual outcomes that result from the plays made in actual football games by the football players that the Player has drafted onto his fantasy team. The play analysis algorithms are then loaded 210 into a wagering game processor. The wagering game processor may be the data analysis processor 50 or the House processor 60 (FIG. 1).

A Player of the wagering game then drafts 212 a fantasy team of players, i.e., the Player defines a virtual sports team comprised of members of actual teams engaged in playing live sports game events that are occurring at that time or on that day. The listing of the players on the game Player's fantasy team is uploaded 214 to the wagering game processor 50 or 60.

Real time streaming game data from all of the relevant live sports game events that are occurring at that time are then continuously acquired. Referring to FIG. 1, the data may be acquired by sensors 72 and cameras 74, and communicated to data analysis processor 70. Again using American football as an example, football play data may be obtained from RFID tags which track real-time location coordinates on players as described previously, from a sensor(s) embedded in the football, from sensors embedded in the football field and/or goalposts, frame weather sensors, and from analysis of images captured by the plethora of cameras recording and transmitting the game as it ensues. The data analysis processor 70 analyzes the play data and outputs real time streaming game data, which may be imported 216 by the wagering game processor 50 or 60.

The House may then offer 218 to the Player an opportunity to place a wager on a next virtual play or series of virtual plays. The offer by the House may be simply to place a simple bet at 1:1 odds. Alternatively, the wagering game processor 50 or 60 may calculate probabilities and odds for a range of different possible outcomes, and may offer the Player the opportunity to choose among different wagering options at different odds. Alternatively, the Player may specify a possible outcome for a next virtual play or series of virtual plays. The wagering game processor 50 or 60 is programmed with an algorithm that includes voice and/or text recognition, and further includes an “AI” (artificial intelligence) algorithm to interpret and determine the meaning of the Player's specification of the next virtual play or series of virtual plays and outcome in the context of the game being played.

The wagering game processor 50 or 60 accesses the data storage medium 40 and imports archival data relevant to the performances of the actual game players on the Players “fantasy team.” Such archival data may include the player's performance in previous sporting events, his previous performance in that sporting event, and other players' performances in previous and present sporting events. The wagering game processor 50 or 60 may also obtain real time data from the data analysis processor 70 on the sporting events that are occurring in real time, which in turn may have acquired such data from the sensors 72 and image capture devices 74. The analysis of the Player's specified virtual event and outcome are done in real time in a matter of seconds after the Player's specified event and outcome are entered at the gaming station, such that in seconds after entry, the Player is offered 218 odds by the House for wagering on his specified virtual event and outcome.

While the Player is considering his options to wager, a cutoff timer 219 is present and counting down on the display screen as described previously. If the Player accepts the offer(s) from the House, and places a wager, the House receives 220 the wager from the Player. From that point, in real time over a time of about ten seconds up to a minute, plays ensue in the actual games that are being played by teams that include the game players on the Player's fantasy team. For example, as a set of six to eight football professional football games are being played, the performances of game Players in at least one additional next play that ensues are monitored, and data on their performance in real time is obtained and analyzed 224 by the wagering game processor 50 or 60 according to the play analysis algorithms. During this time, the actual games that are being played by teams that include the game players on the Player's fantasy team may be displayed on the display 22 of the Player's gaming station 20. In that manner, by seeing the various plays by members of his fantasy team, the Player will experience greater excitement in playing the wagering game. It is to be understood that the Player's fantasy team may be comprised of both offensive and defensive players of the actual games, and that plays upon which wagers may be placed may be from an offensive or defensive standpoint. It is also to be understood that while not all members of a Player's fantasy team will be engaged on any one play, a sufficient number of members will be engaged over the time of the at least one additional play in the various games that are ensuing, such that results of a next play in a virtual game can be calculated.

The gaming method may further comprise, based on the performances of the members of the virtual team in the at least one additional next play in the actual games that the respective members of the virtual team are playing, determining 225 if the outcome specified by the Player is the outcome calculated according to the virtual game algorithm. If the outcome specified by the Player is not the outcome calculated according to the virtual game algorithm, the wagering game ends 226, and the wager of funds is kept by the House. If the outcome specified by the Player is the outcome calculated according to the virtual game algorithm, the Player is offered 227 two choices. A first choice is for the Player to accept 228 a first payout from the House of W times the first wager of funds, wherein W is a function of a probability, calculated according to the virtual game algorithm, of the occurrence of the outcome specified by the Player. A second choice is for the Player to continue play 229, wagering the funds of the first wager and the first payout on the outcome of an additional next play in the virtual game. Playing of the game may then continue, with repeated cycles 230 occurring for as long as the Player continues to attain winning outcomes.

Referring again to FIG. 6, in certain embodiments of the game 200, the House rules may stipulate that for the Player to have the option to continue play in pursuit of a higher level of payout, the number of winning wagers must exceed a certain threshold, which is checked at gate 225A. In a parlay-type wagering arrangement, the House rules may require that a minimum number of events must be wagered upon before the House begins to offer the “Option A” and Option B″ choices.

Referring again to FIG. 1, the gaming system 10 may be provided with the capability to operate a wagering game as described above with reference to FIG. 6. The master processor 60 or peripheral processor 50, or an additional processor 90 of the system 10 may be operable to execute a virtual game algorithm to analyze input data from the gaming station 20. The input data may define a virtual team of members selected by the Player, wherein the virtual members of the virtual team are members of actual teams engaged in playing live game events in a competitive sport. The algorithm may further analyze live events output data, and communicate the Player's wagering options to the gaming station 20 for wagering on a next play in a virtual game. The algorithm may further include steps to receive a wager input by the Player at the gaming station 20 on a future outcome, specified by the Player, of at least one additional next play in the virtual game, and to monitor the performance of the virtual members of the virtual team in the live game events in at least one additional next play in actual games that the respective members of the virtual team are playing.

Subsequently, based on the performances of the members of the virtual team in the at least one additional next play in the actual games that the respective members of the virtual team are playing, the algorithm may calculate an outcome of the at least one additional next play in the virtual game, and compare the future outcome specified by the Player of the at least one additional next play in the virtual game with the outcome of the at least one additional next play in the virtual game calculated according to the virtual game algorithm. If the future outcome specified by the Player is not the outcome calculated according to the virtual game algorithm, the algorithm is operable to transfer the wager of funds to the House. The virtual game algorithm further includes steps to determine if the future outcome specified by the Player is the outcome calculated according to the virtual game algorithm, and if true, to offer the Player the choice of accepting a first payout from the House of W times the first wager of funds, wherein W is a function of a probability, calculated according to the virtual game algorithm, of the occurrence of the outcome specified by the Player; or wagering the funds of the first wager and the first payout on a future outcome of an additional next play in the virtual game.

In further embodiments of the gaming methods 100P, 100H, and 200 of FIGS. 4-6, the House may operate a “bonus pool” or “jackpot fund” 132 wherein if a Player reaches a threshold of a certain number of consecutive wins in wagers, a jackpot is paid out. Each time a Player loses a wager, a small proportion of the Player's wager of funds retained by the House may be added to the jackpot fund 132. Each time a Player winds a wager, a determination 134 is made, and if the Player has reached the threshold number of consecutive wins specified by the House, the jackpot is paid 136.

It will be apparent that the winning of the jackpot payout outcome will be a rare occurrence, and will have a payout much higher than other payouts for other winning occurrences. It will be further apparent that the game may be played over and over again, perhaps millions of times, without this lowest probability/highest jackpot payout outcome occurring. In certain embodiments, to make the game more attractive to prospective Players, each time the game is played, and the lowest probability/highest payout outcome does not occur, the House incrementally increases the payout for the next occurrence of that outcome. Thus the maximum payout includes a pool of funds that continually increases until a Player achieves the lowest probability winning outcome, i.e. “hits the jackpot.”

### Example—Parlay Game Based Upon N Indeterminate Events

An example of the gaming method of the present disclosure as applied to a parlay game will now be described with reference to FIGS. 1, 4, and 5. From the standpoint of the House (FIG. 4), preparations are made for offering the game to Players, by data importing steps 101 and 103, as described previously. From the standpoint of the Player (FIG. 5), the Player chooses 102 a set of N future events. The N future events may be presented 104 on a display 22. (For example, in FIG. 2, N=9 events.) With the Player's N events specified, the House processor 60 or peripheral processor 50 executes an algorithm to calculate 105 probabilities and odds of possible outcomes of the N events, and communicates such odds to the gaming station 20, and thus to the Player. The Player places 106 his first wager of funds, and the House receives 109 the first wager of funds of a defined value from a Player. In making the wager, the Player specifies a wagered outcome for each one of a plurality of N future events, with each one of the plurality of N future events having at least two possible outcomes.

In certain embodiments, the N future events do not occur simultaneously, but instead occur in sequence, such that subsequent additional wagering decisions can be made. In such embodiments, the method further comprises observing 110 the occurrence of a subset of M future events of the N future events, M being less than N, and determining actual outcomes of the M future events. Data on the M future events are analyzed 115. The actual outcomes of the M future events are compared 117 with the wagered outcomes of the M future events specified by the Player. If any one of the actual outcomes of the M future events is not the wagered outcome specified by the Player for that event, the defined value of the wager of funds is kept by the House, and the game ends 119.

If the actual outcomes of each of the M future events are the wagered outcomes specified by the Player for each of the M future events, the Player is offered 121 two choices. A first choice is for the Player to accept a first payout 123 of W times the defined value of the funds of the first wager from the House, wherein W is a function of the probability of the actual outcomes of each of the M future events being the wagered outcomes specified by the Player for each of the M future events. A second choice is to continue play 125, wagering the funds of the first wager and the first payout on a wagered outcome of an additional one of the remaining events of the N future events.

Referring to FIG. 5, if the Player wishes to wager the funds of the first wager and the first payout, the Player selects 131 an additional one of the remaining events of the N future events, specifies the outcome of which he wagers will occur, and places 133 his wager accordingly. The additional one of the remaining events of the N future events occurs 135 and is observed. The data analysis processor 70 analyzes the data on the event, and determines the actual outcome of the event. The data analysis processor 70 communicates the outcome of the event to the house processor 60 or the peripheral processor 50. The house processor 60 or peripheral processor 50 compares 137 the actual outcome of the event with the outcome specified by the Player in his wager.

If the actual outcome of the additional one of the remaining events is not the wagered outcome of the additional one of the remaining events specified by the Player, no first payout from the House to the Player is made. The defined value of the first wager of funds is kept by the House, and the game ends 139. If the actual outcome of the additional one of the remaining events is the wagered outcome of the additional one of the remaining events specified by the Player, the Player is offered 141 two choices. A first choice is to accept a second payout 143 of X times the defined value of the funds of the first wager from the House, wherein X is a function of the probability of the actual outcomes of each of the M+1 future events being the wagered outcomes specified by the Player for each of the M+1 future events. A second choice 145 is wagering the funds of the first wager and the second payout on a wagered outcome of an additional one of the remaining events of the N future events.

If the Player wishes to wager the funds of the first wager and the first payout, the Player selects 151 an additional one of the remaining events of the N future events, specifies the outcome of which he wagers will occur, and places 153 his wager accordingly. The additional one of the remaining events of the N future events occurs 155 and is observed. The data analysis processor 70 analyzes the data on the event, and determines the actual outcome of the event. The data analysis processor 70 communicates the outcome of the event to the house processor 60 or the peripheral processor 50. The house processor 60 or peripheral processor 50 compares 157 the actual outcome of the event with the outcome specified by the Player in his wager.

If the actual outcome of the additional one of the remaining events is not the wagered outcome of the additional one of the remaining events specified by the Player, no first payout from the House to the Player is made. The defined value of the first wager of funds is kept by the House, and the game ends 149. If the actual outcome of the additional one of the remaining events is the wagered outcome of the additional one of the remaining events specified by the Player, the Player is offered 151 two choices. A first choice is to accept a third payout 153 of Y times the defined value of the funds of the first wager from the House, wherein Y is a function of the probability of the actual outcomes of each of the M+2 future events being the wagered outcomes specified by the Player for each of the M+2 future events. A second choice 155 is wagering the funds of the first wager and the third payout on a wagered outcome of an additional one of the remaining events of the N future events.

In general, if the Player does not accept a second payout of X times the defined value of the funds of the first wager from the House, the gaming method may further comprise the Player repeating the cycle 130P, wagering the funds of the first wager plus a multiple of the defined value of the funds of the first wager on a wagered outcome of an additional one of the remaining events specified by the Player, and attaining an additional match of the wagered outcome of that additional one of the remaining events specified by the Player with the actual outcome of that additional one of the remaining events, until all of the remaining future events of the N future events have occurred, and all of the actual outcomes of the N future events match the wagered outcomes of the N future events specified by the Player. In certain embodiments, the gaming method may further comprise paying funds from a jackpot fund 132, which (as described previously) contains funds incrementally increased in each prior practice of the gaming method in which, for each Player of the gaming method, that Player does not attain a match of wagered outcomes specified by that Player of N future events with the actual outcomes of those N future events.

It is therefore apparent that there has been provided, in accordance with the present disclosure, systems and methods of operating and playing games of chance. Having thus described the basic concept of the invention, it will be apparent to those skilled in the art that the foregoing detailed disclosure is intended to be presented by way of example only, and is not limiting. Various alterations, improvements, and modifications will occur to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed gaming methods to any order except as may be expressly stated in the claims.

What is claimed is:

1. A gaming method operable by a House and comprising:
a) identifying a plurality of N future events as potential wagering events, each one of the plurality of N future events having at least two possible outcomes;
b) for each of the N future events, calculating in real time the probabilities of possible outcomes thereof;
c) for each of the N future events, communicating wagering options on the possible outcomes to a Player;
d) accepting a first wager of funds of a defined value from a Player, the wager specifying a wagered outcome for each one of a plurality of N future events;
e) observing an occurrence of a subset of M future events of the N future events, M being less than N, and determining actual outcomes of the M future events in real time;
f) comparing the actual outcomes of the M future events with the wagered outcomes of the M future events specified by the Player;
g) if any one of the actual outcomes of the M future events is not the wagered outcome specified by the Player for that event, transferring the defined value of the wager of funds to the House; and
h) if the actual outcomes of each of the M future events are the wagered outcomes specified by the Player for each of the M future events, offering the Player the choice of:
accepting a first payout of W times the defined value of the funds of the first wager from the House, wherein W is a function of the probability of the actual outcomes of each of the M future events being the wagered outcomes specified by the Player for each of the M future events; or
wagering the funds of the first wager and the first payout on a wagered outcome of an additional one of the remaining events of the N future events.

2. The method of claim 1, further comprising:
a) if the Player accepts the first payout, transferring the first payout of funds from the House to the Player;
b) if the Player wagers the funds of the first wager and the first payout, observing an occurrence of an additional one of the remaining events of the N future events, and determining an actual outcome of that one of the remaining events in real time;
c) comparing the actual outcome of the additional one of the remaining events with the wagered outcome of the additional one of the remaining events specified by the Player;
d) if the actual outcome of the additional one of the remaining events is not the wagered outcome of the additional one of the remaining events specified by the Player, making no first payout from the House to the Player, and transferring the defined value of the first wager of funds to the House; and
e) if the actual outcome of the additional one of the remaining events is the wagered outcome of the additional one of the remaining events specified by the Player, offering the Player the choice of:
accepting a second payout of X times the defined value of the funds of the first wager from the House, wherein X is a function of the probability of the actual outcomes of each of the M+1 future events being the wagered outcomes specified by the Player for each of the M+1 future events, or
wagering the funds of the first wager and the second payout on a wagered outcome of an additional one of the remaining events of the N future events.

3. The method of claim 2, further comprising:
a) if the Player accepts the second payout, transferring the second payout of funds from the House to the Player;
b) if the Player wagers the funds of the first wager and the second payout, observing an occurrence of an additional one of the remaining events of the N future events, and determining an actual outcome of that one of the remaining events in real time;
c) comparing the actual outcome of that additional one of the remaining events with the wagered outcome of that additional one of the remaining events specified by the Player;
d) if the actual outcome of that additional one of the remaining events is not the wagered outcome of that additional one of the remaining events specified by the Player, making no second payout from the House to the Player, and transferring the defined value of the first wager of funds to the House; and
e) if the actual outcome of that additional one of the remaining events is the wagered outcome of that additional one of the remaining events specified by the Player, offering the Player the choice of:
accepting a third payout of Y times the defined value of the funds of the first wager from the House, wherein Y is a function of the probability of the actual outcomes of each of the M+2 future events being the wagered outcomes specified by the Player for each of the M+2 future events, or
wagering the funds of the first wager and the third payout on a wagered outcome of an additional one of the remaining events of the N future events.

4. The method of claim 2, further comprising the Player repeatedly wagering the funds of the first wager plus a multiple of the defined value of the funds of the first wager on a wagered outcome of an additional one of the remaining events specified by the Player, and attaining an additional match of the wagered outcome of that additional one of the remaining events specified by the Player with the actual outcome of that additional one of the remaining events, until all of the remaining future events of the N future events have occurred, and all of the actual outcomes of the N future events match the wagered outcomes of the N future events specified by the Player.

5. The method of claim 4, further comprising paying funds from a bonus pool containing funds incrementally increased in each prior practice of the gaming method in which, for each Player of the gaming method, that Player does not attain a match of wagered outcomes specified by that Player of N future events with the actual outcomes of those N future events.

6. The method of claim 1, wherein the occurrence of the N future events and the wagering options of the N future events are viewable on an image display in real time, and wherein specifying the wagered outcome for each one of the plurality of N future events is input in real time to a computer via a user interface that is in communication with the computer.

7. The method of claim 6, wherein the computer executes an algorithm to analyze input data upon the occurrences of each of the N future events, and determines in real time the outcomes of each of the N future events.

8. The method of claim 6, wherein the occurrence of a subset of P future events of the N future events is viewable on an image display, P being less than or equal to M, and the Player first specifies a wagered outcome for each one of the P future events, the method further comprising:
a) observing the occurrence of the subset of P future events of the N future events, and determining actual outcomes of the P future events in real time;
b) comparing the actual outcome of the P future events with the wagered outcomes of the P future events specified by the Player in real time; and
c) if any one of the actual outcomes of the P future events is not the wagered outcome specified by the Player for that event, transferring the defined value of the wager of funds to the House.

9. The method of claim 8, wherein P is equal to M, and wherein if the actual outcomes of each of the M future events are the wagered outcomes specified by the Player for each of the M future events, offering the Player the choice of:
accepting a first payout of W times the defined value of the funds of the first wager from the House, wherein W is a function of the probability of the actual outcomes of each of the M future events being the wagered outcomes specified by the Player for each of the M future events; or
wagering the funds of the first wager and the first payout on the wagered outcome of an additional one of the remaining events of the N future events.

10. The method of claim 9, wherein the Player chooses to wager the funds of the first wager and the first payout on a wagered outcome of an additional one of the remaining events of the N future events, the occurrence of the additional one of the remaining events is viewable on the image display in real time, and wherein the method further comprises the Player specifying the wagered outcome for the at least one of the remaining N future events via the user interface in communication with the computer.

11. The method of claim 10, further comprising:
a) observing an occurrence of the additional one of the remaining events of the N future events, and determining an actual outcome of that one of the remaining events in real time;
b) comparing the actual outcome of the additional one of the remaining events with the wagered outcome of the additional one of the remaining events specified by the Player;
c) if the actual outcome of the additional one of the remaining events is not the wagered outcome of the additional one of the remaining events specified by the Player, making no first payout from the House to the Player, and transferring the defined value of the first wager of funds to the House; and
d) if the actual outcome of the additional one of the remaining events is the wagered outcome of the additional one of the remaining events specified by the Player, offering the Player the choice of:
accepting a second payout of X times the defined value of the funds of the first wager from the House, wherein X is a function of the probability of the actual outcomes of each of the M+1 future events being the wagered outcomes specified by the Player for each of the M+1 future events, or
wagering the funds of the first wager and the second payout on a wagered outcome of an additional one of the remaining events of the N future events.

12. The method of claim 8, wherein P is less than M, and the method further comprises the Player repeatedly wagering the funds of the first wager on a wagered outcome of an additional one of the remaining events of the subset of M future events, until all of the remaining future events of the subset of M future events have occurred, and all of the actual outcomes of the subset of M future events determined in real time match the wagered outcomes of the subset of M future events specified by the Player.

13. The method of claim 8, wherein P is less than M, and the method further comprises:
the Player repeatedly wagering the funds of the first wager on a wagered outcome of an additional one of the remaining events of the subset of M future events, until for one of the remaining future events of the subset of M future events, the actual outcome determined in real time of that one of the remaining future events of the subset of M future events does not match the wagered outcome of that one of the remaining future events of the subset of M future events specified by the Player; and
transferring the defined value of the wager of funds to the House.

14. The method of claim 6, wherein the computer is in communication with a non-transitory storage medium containing archival data predictive of possible outcomes the plurality of N future events, and wherein the computer executes an algorithm to analyze the archival data and calculate in real time the probabilities of the possible outcomes of the plurality of N future events.

15. The method of claim 1, wherein the Player defines at least one of the future events and a specific actual outcome that he wagers will occur for the at least one future event.

16. The method of claim 15, wherein the defining the at least one future event and the defining the specific actual outcome for the at least one future event are input to a computer via a user interface that is in communication with the computer.

17. The method of claim 16, wherein the computer executes an algorithm to recognize the Player-defined at least one future event and specific outcome thereof, and calculates in real time a probability of the specific actual outcome defined by the Player for the at least one future event.

18. The method of claim 17, wherein the computer calculates odds for the specific actual outcome for the at least one future event, and communicates the odds to the Player in real time.

19. The method of claim 18, wherein the Player specifies a wagered outcome for the at least one future event.

20. A method of operating a wagering game by a House, using a computer, the method comprising:
a) identifying a plurality of actual live sports games being played in real time by actual sports teams and communicating data on the live sports games in real time to a gaming station operable by a Player;
b) accepting by the House input from a Player of the wagering game, the input defining a virtual sports team comprised of members of actual sports teams engaged in playing the live sports games;
c) accepting by the House a first wager of funds on an outcome, specified by the Player, of at least one additional next play in the wagering game;
d) monitoring the individual performances of the members of the virtual team in at least one additional next play in the respective live sports games that the respective members of the virtual team are playing;
e) based on the performances of the members of the virtual team in the at least one additional next play in the respective live sports games that the respective members of the virtual team are playing, executing by the computer a wagering game algorithm to calculate in real time an outcome of the at least one additional next play in the wagering game;
f) comparing the outcome specified by the Player of the at least one additional next play in the wagering game with the outcome of the at least one additional next play in the wagering game calculated according to the wagering game algorithm; and
g) if the outcome specified by the Player is not the outcome calculated according to the wagering game algorithm, transferring the wager of funds to the House.

21. The gaming method of claim 20, further comprising determining if the outcome specified by the Player is the outcome calculated according to the virtual game algorithm, and if true, offering the Player the choice of:
accepting a first payout from the House of W times the first wager of funds, wherein W is a function of a probability, calculated according to the virtual game algorithm, of the occurrence of the outcome specified by the Player; or
wagering the funds of the first wager and the first payout on the outcome of an additional next play in the virtual game.

22. The gaming method of claim 20, further comprising defining a list of possible game play outcomes, calculating odds for each possible game play outcome, and defining a hierarchy of possible game play outcomes based upon the calculated odds for each possible game play outcome.

23. The gaming method of claim 22, further comprising defining a play analysis algorithm executable by the computer and operable to analyze outcomes of previous plays of members of the actual teams engaged in playing the live game events, and calculate a “virtual outcome” of a virtual play.

24. A method of operating a wagering game by a House, using a computer, the method comprising:
a) receiving input from a Player to the computer via a gaming station operated by the Player, the input identifying a specified future indeterminate event, and a specified possible outcome of the specified future indeterminate event;
b) communicating to the computer archival input data from a non-transitory data storage medium on past events relevant to possible outcomes of the specified future indeterminate event;
c) communicating to the computer live input data from at least one of a sensor or an imaging device acquiring the live input data at the future indeterminate event;
d) executing by the computer an algorithm to calculate the probability of the specified possible outcome of the specified future indeterminate event, and odds for the specified possible outcome of the specified future indeterminate event;
e) communicating the odds to the Player via the gaming station;
f) receiving from the Player to the computer via the gaming station a first wager of funds of a defined value from a Player, the wager being that the specified possible outcome of the specified future indeterminate event will occur;
g) communicating to the computer live input data from the at least one sensor or imaging device in real time indicative of the actual outcome of the specified future indeterminate event;
h) comparing by the computer the actual outcome of the specified future indeterminate event with the specified possible outcome defined by the Player; and
i) if the actual outcome of the specified future indeterminate event is not the specified possible outcome defined by the Player, transferring the defined value of the wager of funds to the House.

25. The gaming method of claim 24, wherein if the actual outcome of the specified future indeterminate event is the specified possible outcome defined by the Player, the gaming method further comprises making a payout to the Player of W times the defined value of the funds of the first wager from the House, wherein W is a function of the probability calculated via the algorithm of the actual outcome of the specified future indeterminate event being the specified possible outcome defined by the Player.

26. The gaming method of claim 24, wherein if the actual outcome of the specified future indeterminate event is the specified possible outcome defined by the Player, the gaming method further comprises offering the Player the choice of accepting a first payout of W times the defined value of the funds of the first wager from the House, wherein W is a function of the probability calculated via the algorithm of the actual outcome of the specified future indeterminate event being the specified possible outcome defined by the Player; or wagering the funds of the first wager and the first payout on a wagered outcome of an additional future indeterminate event.

27. The gaming method of claim 24, wherein the specified future indeterminate event is a sporting event.

28. The gaming method of claim 24, wherein the specified future indeterminate event is an election event.

29. The gaming method of claim 24, wherein the specified future indeterminate event is an event observed by an Internet of Things sensor or Internet of Things image capture device.
